(19) United States
(12) Patent Application Publication
(10) Pub. No.: US 2008/0054817 A1
(43) Pub. Date: Mar. 6, 2008

(54) DRIVING APPARATUS OF LIGHT SOURCE

(75) Inventors: Chin-Fa Kao, Taipei City (TW); Chung-Che Yu, Taipei City (TW); Chia-Wei Wang, Taipei City (TW); Chien-Pang Hung, Taipei City (TW)

Correspondence Address: J C PATENTS, INC., 4 VENTURE, SUITE 250, IRVINE, CA, 92618, US

(73) Assignee: BEYOND INNOVATION TECHNOLOGY CO., LTD., Taipei City (TW)

(21) Appl. No.: 11/671,241

(22) Filed: Feb. 5, 2007

(30) Foreign Application Priority Data
Sep. 5, 2006 (TW) 95132701

(51) Int. Cl. H05B 39/04

(52) U.S. Cl. 315/209 R

(57) ABSTRACT

A driving apparatus used for driving a light source is provided. The driving apparatus includes a signal processing unit, a control unit, and a driving unit. The signal processing unit generates an enabling signal and a dimming signal according to an input signal. The control unit includes an enabling module and a dimming module. The enabling module enables the driving apparatus according to the enabling signal, and the dimming module generates a dimming driving signal according to the dimming signal. The driving unit adjusts the brightness of the light source according to the dimming driving signal.

### CROSS-REFERENCE TO RELATED APPLICATION

This application claims the priority benefit of Taiwan application serial no. 95137201, filed on Sep. 5, 2006. All disclosure of the Taiwan application is incorporated herein by reference.

### BACKGROUND OF THE INVENTION

1. Field of the Invention

The present invention relates to a driving apparatus of a light source, and more particularly to a driving apparatus that can be enabled in response to receiving only an input signal, wherein the degree of dimming of the light source can also be determined through the input signal.

2. Description of Related Art

With the addition of more functions to displays, the complexity of the integrated circuit (IC) deployed by the displays also increases correspondingly. As a result, the integrated circuit needs to receive different types of control signals in order to satisfy the functions demanded by the consumers. The control circuit used for adjusting the intensity of the light source inside a display as shown in FIG. 1 is a good example.

FIG. 1 is a block diagram showing the input signals of a conventional control circuit. The control circuit 101 is used for adjusting the light intensity of the light source 102. The control circuit 101 is implemented using an integrated circuit specially designed for adjusting the light source 102. The light source 102 may be composed of cold cathode fluorescent lamps (CCFL) or light-emitting diodes (LED). The control circuit 101 is enabled in response to receiving an enabling signal ES. When the control circuit 101 is enabled, a pulse width modulation (PWM) signal is also output to drive and light up the light source 102. Also, when the control signal 101 is enabled, the pulse width of the PWM signal is determined by a dimming signal DS received by the control circuit 101 so that the light intensity of the light source 102 is in turn determined by the pulse width of the PWM signal.

When the PWM signal appears in a high potential for a longer period, the light source 102 is conductive for a longer period so that the light source 102 is brighter. On the contrary, when the PWM signal appears in a high potential for a shorter period, the light source 102 is conductive for a shorter period so that the light source 102 is dimmer.

However, because the control circuit 101 needs to receive the independent control signals including both the enabling signal ES and the dimming signal DS before taking any actions, the manufacturers have to additionally provide an enabling signal ES and a dimming signal DS to the control circuit 101. In other words, the manufacturers have to make use of additional circuits to generate the two independent control signals, namely, the enabling signal ES and the dimming signal DS, and control the states of the two signals. Thus, not only is the production cost increased, the circuit is harder to design as well.

### SUMMARY OF THE INVENTION

Accordingly, at least one objective of the present invention is to provide a driving apparatus that can be enabled in response to receiving only an input signal, wherein the degree of dimming of the light source can also be determined through the input signal.

At least another objective of the present invention is to provide a driving apparatus that can be manufactured at a lower cost.

At least another objective of the present invention is to provide a driving apparatus whose circuit is easier to design.

At least yet another objective of the present invention is to provide a driving apparatus with temperature-compensating capability.

To achieve these and other advantages and in accordance with the purpose of the invention, as embodied and broadly described herein, the invention provides a driving apparatus of a light source. The driving apparatus includes a signal processing unit, a control unit, and a driving unit. The signal processing unit generates an enabling signal and a dimming signal according to an input signal. The control unit includes an enabling module and a dimming module. The enabling module enables the driving apparatus according to the enabling signal, and the dimming module generates a dimming driving signal according to the dimming signal. The driving unit adjusts the brightness of the light source according to the dimming driving signal.

The present invention also provides a driving apparatus of a light source for receiving a dimming signal. The driving apparatus includes a temperature-compensating device, a control unit, and a driving unit. The temperature-compensating device receives the dimming signal. The control unit has a negative adjusting dimming module. The dimming module is coupled to the temperature-compensating device and generates a dimming driving signal according to the dimming signal. The driving unit adjusts the brightness of the light source according to the dimming driving signal. When the surrounding temperature rises, the temperature-compensating device adjusts the dimming signal so that the current flowing to the light source is reduced.

According to an embodiment of the present invention, the foregoing signal processing unit generates the enabling signal and the dimming signal according to the voltage level of the input signal.

According to an embodiment of the present invention, the foregoing signal processing unit includes a first signal processing circuit and a second signal processing circuit. The first signal processing circuit is coupled to the enabling module for generating an enabling signal according to the voltage level of the input signal, and when the supplied input signal ends, the enabling signal is still maintained for a preset time period. The second signal processing circuit is coupled to the dimming module for generating the dimming signal according to the voltage level of the input signal.

According to an embodiment of the present invention, the foregoing first signal processing circuit includes a first diode, a first impedance, a second impedance, and a third impedance. The anode of the first diode receives the input signal. The first impedance is coupled between the cathode of the diode and the enabling module. The second impedance is coupled between the first impedance and a common potential. The third impedance is coupled between the first impedance and the common potential. In the present embodiment, the first impedance and the second impedance are implemented using resistors and the third impedance is implemented using a capacitor.

According to an embodiment of the present invention, the foregoing second signal processing circuit includes a fourth impedance, a fifth impedance and a second diode. One of the terminals of the fourth impedance receives the input signal. The fifth impedance is coupled between the other terminal of the fourth impedance and a common potential. The anode of the second diode is coupled to the other terminal of the fourth impedance and the cathode of the second diode is coupled to the dimming module. In the present embodiment, the fourth impedance and the fifth impedance are implemented using resistors.

According to an embodiment of the present invention, the foregoing input signal includes a DC signal.

According to an embodiment of the present invention, the foregoing input signal includes a pulse width modulation (PWM) signal, and the dimming module determines the dimming driving signal for adjusting the brightness of the light source according to the duty cycle of the PWM signal.

According to an embodiment of the present invention, the foregoing temperature-compensating device is a diode, moreover, it is the aforementioned second diode.

According to an embodiment of the present invention, the foregoing temperature-compensating device is a thermal resistor, moreover, it is the aforementioned fifth impedance.

In brief, the present invention adopts a signal processing circuit to receive an input signal and uses the signal processing circuit to generate an enabling signal and a dimming signal according to the voltage level of the input signal. Therefore, the driving apparatus of the present invention only have to receive an input signal to be enabled. Moreover, the degree of dimming of the light source is also determined by the input signal. Thus, there is no need for the manufacturers to provide additional circuits for generating the two independent control signals including the enabling signal ES and the dimming signal DS and there is no need to control the states of the two signals using the foregoing circuits. Consequently, the production cost is reduced and the circuit is easier to design. Furthermore, a temperature-compensating device can be provided in the present invention to achieve the effect of temperature compensation.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the input signals of a conventional control circuit.

FIG. 2 is a block diagram of a driving apparatus according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a block diagram of a driving apparatus according to one preferred embodiment of the present invention. As shown in FIG. 2, the driving apparatus is used for adjusting the light intensity of a light source 210. The light source 210 can be cold cathode fluorescent lamps or light-emitting diodes, or a cold cathode fluorescent lamp module or a light-emitting diode module set up as a back light module, or other types of light-emitting devices.

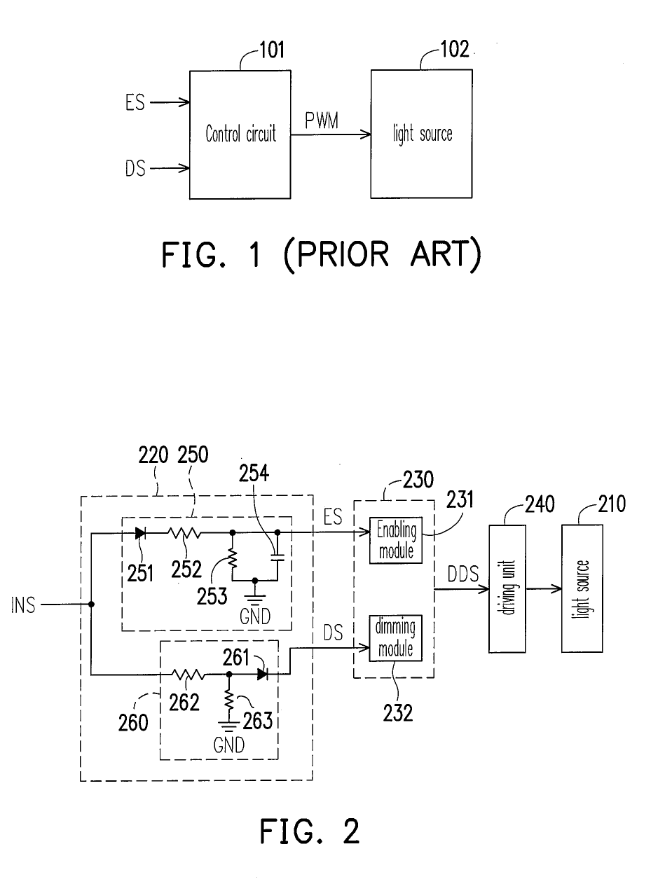

The driving apparatus in the present embodiment includes a signal processing unit 220, a control unit 230 and a driving unit 240. The signal processing unit 220 generates an enabling signal ES and a dimming signal DS according to the voltage level of an input signal INS. The function of the control unit 230 is similar to the control circuit 101 shown in FIG. 1. The control unit 230 has an enabling module 231 and a dimming module 232. The enabling module 231 enables the driving apparatus according to the enabling signal ES, and the dimming module 232 generates a dimming driving signal (DDS) (in the present embodiment, the dimming driving signal (DDS) is a pulse width modulation (PWM) signal) according to the dimming signal DS. The driving unit 240 adjusts the brightness of the light source 210 according to the dimming driving signal DDS.

The foregoing signal processing circuit 220 includes a first signal processing circuit 250 and a second signal processing circuit 260. The first signal processing circuit 250 is coupled to the enabling module 231 for generating an enabling signal ES according to the voltage level of the input signal INS, and when the supplied input signal ends, the enabling signal ES is still maintained for a preset time period. The second signal processing circuit 260 is coupled to the dimming module 232 for generating the dimming signal DS according to the voltage level of the input signal INS.

The first signal processing circuit 250 includes a diode 251, a first impedance, a second impedance and a third impedance. In the present embodiment, the first impedance and the second impedance are implemented using resistors 252 and 253 respectively, and the third impedance is implemented using a capacitor 254. The anode of the diode 251 receives the input signal INS. The first impedance is coupled between the cathode of the diode 251 and the enabling module 231. One of the terminals of the second impedance is coupled to the enabling module 231 and the first impedance and the other end of the second impedance is coupled to a common potential GND. The third impedance and the second impedance are connected in parallel.

The second signal processing circuit 260 includes a diode 261, a fourth impedance and a fifth impedance. In the present embodiment, the fourth impedance and the fifth impedance are implemented using resistors 262 and 263 respectively. One of the terminals of the fourth impedance receives the input signal INS. The fifth impedance is coupled between the other terminal of the fourth impedance and the common potential GND. The anode of the second diode 261 is coupled to the other terminal of the fourth impedance, and the cathode of the second diode 261 is coupled to the dimming module 232.

After describing the various components of the driving apparatus in the present embodiment and their relationships with each other, the operation of the driving apparatus when the input signal INS is a DC signal is described below.

To simplify the description, the dimming module 232 is assumed to operate on the basis of a negative adjustment of the light source. Furthermore, the enabling module 231 determines whether to enable the driving apparatus so as to drive and light up the light source 210 according to the voltage of the enabling signal ES, and the dimming module 232 determines the degree of adjustment of the dimming driving signal DDS according to the voltage of the dimming signal DS. In addition, it is also assumed that the threshold operating voltage of the dimming module 232 is greater than the threshold operating voltage of the enabling module 231. If the voltage of the enabling signal ES is greater than the threshold operating voltage of the enabling module 231, the driving apparatus is enabled. Similarly, if the voltage of the dimming signal DS is greater than the threshold operating voltage of the dimming module 232, the dimming module 232 may perform a dimming adjustment.

When the input signal INS supplies a voltage, and the division of voltage across the resistor 253 (the enabling signal ES) is smaller than the threshold operating voltage of the enabling module 231 and the voltage across the resistor 263 (the dimming signal DS) is also smaller than the threshold operating voltage of the dimming module 232, the driving apparatus is in a shut-off state and dimming adjustment is not possible.

When the input signal INS supplies a voltage, and the voltage level of the input signal INS is adjusted upward until the division of voltage across the resistor 253 is greater than the threshold operating voltage of the enabling module 231 but the voltage across the resistor 263 is still smaller than the threshold operating voltage of the dimming module 232, the driving apparatus is enabled and the driving unit 240 begins to drive and light up the light source 210. However, because the voltage across the resistor 263 is still smaller than the threshold operating voltage of the dimming module 232, the dimming module 232 has not been enabled. Hence, the dimming module 232 generates no dimming driving signal DDS. In other words, although the driving apparatus can drive and light up the light source 210, the dimming function is not executed.

When the input signal INS supplies a voltage, and the voltage level of the input signal INS is adjusted upward until the division of voltage across the resistor 253 is greater than the threshold operating voltage of the enabling module 231 and the voltage across the resistor 263 is also larger than the threshold operating voltage of the dimming module 232, the driving apparatus is enabled to drive and light up the light source 210. Because the voltage across the resistor 263 is larger than the threshold operating voltage of the dimming module 232, the dimming module 232 has been enabled. Therefore, the dimming module 232 adjusts the pulse width of the dimming driving signal DDS according to the voltage of the received dimming signal DS. In other words, the driving apparatus not only drives and lights up the light source 210, but also executes the dimming function.

Because the dimming module 232 operates on the basis of a negative adjustment of the light source, the larger the division of voltage across the resistor 263, the larger the voltage of the dimming signal DS will be. The larger the voltage of the dimming signal DS, the shorter the period of the dimming driving signal DDS appearing in a high potential and hence the dimmer the light source 210 will be. Conversely, the smaller the division of voltage across the resistor 263, smaller the voltage of the dimming signal DS will be. The smaller the voltage of the dimming signal, longer the period of the dimming driving signal DDS appearing in a high potential and hence the brighter the light source 210 will be.

When the supplied input signal INS ends, the entire driving apparatus is shut down so that the light source 210 is automatically turned off. Although the description of the foregoing actions is based on the negative adjustment of the light source, those skilled in the art may easily modify the present invention using a dimming module 232 operating on the basis of a ‘positive adjustment’ of the light source. The so-called positive adjustment means that the larger the voltage of the dimming signal DS, longer the period of the dimming driving signal DDS appearing in a high potential and hence the brighter the light source 210 will be. Conversely, the smaller the voltage of the dimming signal DS, the shorter the period of the dimming driving signal DDS appearing in a high potential and hence the dimmer the light source 210 will be.

Therefore, regardless of whether the dimming module 232 operates on the basis of a positive adjustment of the light source or a negative adjustment of the light source, the decision whether to enable the driving apparatus and the decision whether to control the driving apparatus for a dimming adjustment as well as the degree of adjustment of the light source can be effected only by adjusting the voltage of the input signal INS.

The foregoing driving apparatus not only can correctly operate when the input signal INS is a DC signal, but can correctly operate when the input signal is a pulse width modulation (PWM) signal due to the user's need to correspond with the actual design requirements. In the following, the action of the driving apparatus when the input signal INS is a PWM signal is used as an example.

Because the input signal INS is a PWM signal, the dimming module 232 must be able to determine the degree of dimming adjustment according to the duty cycle of the PWM signal. To simplify the explanation, the dimming module 232 is assumed to operate on the basis of a negative adjustment of the light source. Furthermore, the threshold operating voltage of the dimming module 232 is greater than that of the enabling module 232. It is also assumed that, when the input signal INS is at a high logic level, the divided voltages across the resistors 253 and 263 (that is, the voltage of the enabling signal ES and the dimming signal DS) are greater than the threshold operating voltages of the enabling module 231 and the dimming module 232 respectively.

When the input signal INS is a PWM signal and appears as a high logic level (that is, the input signal INS supplies a voltage), the driving apparatus is enabled and is ready to perform the dimming operation because divided voltage across the resistors 253 and 263 are greater than the threshold operating voltages of the enabling module 231 and the dimming module 232 respectively. The degree of dimming is determined by the duty cycle of the input signal INS. In an actual operation, the longer the period of the input signal INS appearing in the high logic level, the shorter the period of the dimming driving signal DDS appearing in the logic high level and hence the dimmer the light source 210 will be. Conversely, the shorter the period of the input signal INS appearing in the high logic level, the longer the period of the dimming driving signal DDS appearing in the logic high level and hence the brighter the light source 210 will be.

When the input signal INS is a PWM signal and appears as a high logic level, the capacitor 254 will store up energy. When the input signal INS appears as a low logic level, the capacitor 254 provides energy to the enabling module 231 to maintain the driving apparatus at the enabling state for a preset time period. The length of the preset time period is approximately equal to the product of the value of the resistor 253 and the capacitor 254. Meanwhile, the diode 251 is used for blocking the current returning to the input signal INS from the capacitor 254 and preventing the capacitor 254 from discharging all its electrical power through this path. In addition, the diode 261 is used for blocking the current returning to the input signal INS from the dimming module 232 and the current returning to the common potential GND from the dimming module 232 so that an open circuit appears and the dimming module 232 is inactive.

According to the foregoing description, by suitably adjusting the discharging period and the capacitance of the capacitor 254, the enabling module 231 is able to receive the electrical energy stored in the capacitor 254 and maintain the enabling state in the driving apparatus when the input signal INS appears in a low logic level. However, the dimming module 232 has no similar energy storage device for supplying electrical power. Therefore, the dimming module 232 cannot perform any dimming operation at this time. In addition, if all the activities in the driving apparatus have to be stopped, what is required is to continuously maintain the input signal INS in the low logic level (that is, when the supplied input signal INS ends). The capacitor 254 will release all the accumulated electrical energy through the resistor 253 so that the enabling signal ES is lowered to a value below the threshold operating voltage and all operations inside the driving apparatus eventually stop.

Although the description of the foregoing actions is based on the negative adjustment of the light source, those killed in the art may easily modify the present invention using a dimming module 232 operating on the basis of a ‘positive adjustment’ of the light source. The so-called positive adjustment means that the longer the period of the input signal INS appearing in the high logic level, the longer the period of the dimming driving signal DDS appearing in a high potential and hence the brighter the light source 210 will be. Conversely, the shorter the period of the input signal INS appearing in a high logic level, the shorter the period of the dimming driving signal DDS appearing in a high potential and hence the dimmer the light source 210 will be.

In addition, under the condition that the foregoing dimming module 232 adopts the method of a negative adjustment of the light source, the surrounding temperature may increase when the dimming module 232 adjusts the light source. The temperature of the diode 261 will increase correspondingly and lead to a decrease in the cut-in voltage. Hence, the voltage across the diode 261 is reduced. As a result, the voltage received by the dimming module 232 will increase and lead to a reduction of the current flowing into the light source 210. In general, the operating current of the light source 210 is expected to decrease when the light source 210 (for example, a light-emitting diode module) is at a high temperature so that the light source can have a longer life span. Therefore, in the present embodiment, the diode 261 is also a temperature-compensating device. Through the special characteristic of the diode 261, the operating current of the light source 210 will decrease when the surrounding temperature increases. In this way, the desirable outcome of compensating the temperature change and extending the life of the light source can be achieved.

In addition, in the present embodiment, the resistor 263 can be a thermal resistor having a positive temperature coefficient. Therefore, as the surrounding temperature increases, the resistance of the resistor 263 increases so that the voltage across the resistor 263 also increases. Consequently, the voltage received by the dimming module 232 is increased resulting in a reduction of the current flowing through the light source 210, thereby achieving the goal of temperature compensation. In addition, in other embodiments, when the dimming module 232 adopts the method of a positive adjustment of the light source, the resistor 263 is a thermal resistor with a negative temperature coefficient. Therefore, when the surrounding temperature increases, the resistance of the resistor 263 decreases leading to a reduction of the voltage across the resistor 263. Consequently, the voltage received by the dimming module 232 is decreased resulting in a reduction of the current flowing through the light source 210, thereby similarly achieving the goal of temperature compensation.

In summary, by coupling at least one temperature-compensating device (for example, the diode 261 or the thermal resistor 263) and the dimming module 232 of the control unit 220 together, the temperature characteristic of the temperature-compensating device can be utilized to achieve the goal of temperature compensation.

It should be noted that, if the light source 210 is a cold cathode fluorescent lamp (CCFL) or a CCFL module, the driving unit 240 is likely to include a DC-to-AC inverter. The DC-to-AC inverter converts the signal received by the driving unit 240 into an alternating current power source at a desired voltage needed to operate the CCFL or the CCFL module. On the other hand, if the light source 210 is a light-emitting diode or a light-emitting diode module, then the driving unit 240 is likely to include a DC-to-DC converter. The DC-to-DC converter converts the signal received by the driving unit 240 into a voltage needed to operate the light-emitting diode or the light-emitting diode module.

Furthermore, in high-grade driving apparatus design, the user is allowed to feedback the operating state of the light source 210 to the control unit 230 so that the control unit 230 can dynamically change the degree of dimming according to the operating state of the light source 210. More specifically, the serial connection of the resistor with the light source 210 can be utilized to inspect the size of current flowing through the light source 210. Then, the inspection result is fed to the control unit 230 so that the control unit 230 can adjust the current flowing to the light source 210 in a stable environment. Obviously, the main criterion is that the control unit 230 must be equipped with these functions. Moreover, the foregoing control unit may be implemented using a common pulse width modulation (PWM) control chip.

In the foregoing description of the embodiment, although a possible configuration of the signal processing circuit 220 has been described, those skilled in the art would understand that different manufacturers might have a slightly different approach to designing the signal processing circuit 220 to achieve the purpose of the present invention. Therefore, the present invention should not be limited by one possible configuration. In other words, as long as the designed signal processing circuit 220 is capable of generating an enabling signal and a dimming signal according to the voltage level of the received input signal and maintaining the driving state of the driving apparatus for a preset period of time after the supply of the input signal INS has ended, it would be considered to be within the scope of the present invention.

In summary, the present invention adopts a signal processing circuit to receive an input signal and then the signal processing unit generates an enabling signal and a dimming signal according to the voltage level of the input signal. Therefore, the driving apparatus of the present invention only have to receive an input signal to be enabled. Moreover, the degree of dimming of the light source is also determined by the input signal. Thus, there is no need for the manufacturers to provide additional circuits for generating the two independent control signals including the enabling signal ES and the dimming signal DS and there is no need to control the states of the two signals using the foregoing circuits. Consequently, the production cost is reduced and the circuit is easier to design. Furthermore, a temperature-compensating device can be provided to achieve the effect of temperature compensation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving apparatus of a light source for receiving an input signal, comprising:
a signal processing unit, for generating an enabling signal and a dimming signal according to the input signal;
a control unit, having an enabling module and a dimming module, wherein the enabling module enables the driving apparatus according to the enabling signal, and the dimming module generates a dimming driving signal according to the dimming signal; and
a driving unit, for adjusting the brightness of the light source according to the dimming driving signal.

2. The driving apparatus of claim 1, wherein the signal processing unit generates the enabling signal and the dimming signal according to the voltage level of the input signal.

3. The driving apparatus of claim 2, wherein the signal processing unit comprises:
a first signal processing circuit, coupled to the enabling module for generating the enabling signal according to the voltage level of the input signal, and maintaining the enabling signal for a preset time period after the supplied input signal has ended; and
a second signal processing circuit, coupled to the dimming module for generating the dimming signal according to the voltage level of the input signal.

4. The driving apparatus of claim 3, wherein the first signal processing circuit comprises:
a first diode, having an anode for receiving the input signal;
a first impedance, coupled between a cathode of the first diode and the enabling module;
a second impedance, coupled between the first impedance and a common potential; and
a third impedance, coupled between the first impedance and the common potential.

5. The driving apparatus of claim 4, wherein the first impedance and the second impedance comprise resistors and the third impedance comprises a capacitor.

6. The driving apparatus of claim 3, wherein the second signal processing circuit comprises:
a fourth impedance, comprising a first terminal for receiving the input signal;
a fifth impedance, coupled between a second terminal of the fourth impedance and the common potential; and
a second diode, having an anode coupled to the second terminal of the fourth impedance and a cathode coupled to the dimming module.

7. The driving apparatus of claim 6, wherein each of the fourth impedance and the fifth impedance comprise a resistor.

8. The driving apparatus of claim 6, wherein the fifth impedance comprises a thermal resistor.

9. The driving apparatus of claim 8, wherein the dimming module adopts a method based on a negative adjustment of the light source, and the thermal resistor is a thermal resistor with a positive temperature coefficient.

10. The driving apparatus of claim 8, wherein the dimming module adopts a method based on a positive adjustment of the light source, and the thermal resistor is a thermal resistor with a negative temperature coefficient.

11. The driving apparatus of claim 1, wherein the light source comprises a cold cathode fluorescent lamp.

12. The driving apparatus of claim 1, wherein the light source comprises a light-emitting diode.

13. The driving apparatus of claim 1, wherein the input signal comprises a DC signal.

14. The driving apparatus of claim 1, wherein the input signal comprises a pulse width modulation (PWM) signal, and the dimming module sets the dimming driving signal for adjusting a brightness of the light source according to the duty cycle of the PWM signal.

15. The driving apparatus of claim 1, wherein the control unit comprises a pulse width modulation control chip.

16. The driving apparatus of claim 1, wherein the signal processing unit has a temperature-compensating device coupled to the dimming module, and the temperature-compensating device adjusts the dimming signal so that the current flowing through the light source decreases when the surrounding temperature increases.

17. A driving apparatus of a light source for receiving a dimming signal, comprising:
a temperature-compensating device, for receiving the dimming signal;
a control unit, having a negative adjustment dimming module coupled to the temperature-compensation device and generating a dimming driving signal according to the dimming signal; and
a driving unit, for adjusting a brightness of the light source according to the dimming driving signal, wherein the temperature-compensating device adjusts the dimming signal so that the current flowing through the light source decreases when the surrounding temperature increases.

18. The driving apparatus of claim 17, wherein the temperature-compensating device comprises a diode.

19. The driving apparatus of claim 17, wherein the temperature-compensating device comprises a thermal resistor.

20. The driving apparatus of claim 17, wherein the dimming signal comprises a DC signal or a pulse width modulation (PWM) signal.
